(19) United States
(12) Patent Application Publication
(10) Pub. No.: US 2010/0211495 A1
(43) Pub. Date: Aug. 19, 2010

(54) SYSTEMS, METHODS AND COMPUTER PROGRAM PRODUCTS FOR IMPROVING FOREIGN CURRENCY EXCHANGE IN A COMPREHENSIVE PAYMENT HUB SYSTEM

(75) Inventors: Mark D. Zanzot, Huntersville, NC (US); Garrett C. Briggs, Seattle, WA (US); Eric Dryer, Charlotte, NC (US); Anthony B. Calderone, Matthews, NC (US); William Earl Thomas, II, Charlotte, NC (US); Philip Tobin, Huntersville, NC (US); David Todd Frew, Fort Mill, SC (US); Kerry Cantley, Fort Mill, SC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, Charlotte, NC (US)

(21) Appl. No.: 12/434,374

(22) Filed: May 1, 2009

Related U.S. Application Data
(63) Continuation-in-part of application No. 12/370,943, filed on Feb. 13, 2009.

(51) Int. Cl. G06Q 20/00; G06Q 40/00

(52) U.S. Cl. 705/37; 705/40; 705/39

(57) ABSTRACT

Systems, methods, and computer program products are provided for improving foreign currency exchange processing of financial payment requests and, more specifically improving the bid/ask spread in foreign currency exchange so as to increase the profitability realized by the financial institution processing the payment. In accordance with embodiments herein disclosed, international financial payment requests are pooled together based on currency type and payment time requirements to provide for better exchange rates.

### REFERENCE TO CO-PENDING APPLICATION FOR PATENT

The present application is a continuation-in-part of U.S. patent application Ser. No. 12/370,943, entitled, “Systems, Methods and Computer Program Products for Optimizing Routing of Financial Payments,” filed on Feb. 13, 2009, assigned to the assignee of the present application, the contents of which are hereby incorporated by reference in their entirety.

### FIELD

In general, embodiments herein disclosed relate to systems, methods, and computer program products for improving foreign currency exchange processing in a comprehensive payment hub system and, more specifically, improving the bid/ask spread of foreign exchange in a comprehensive payment hub system capable of processing payments irrespective of payment input channel and/or payment output channel.

### BACKGROUND

Currently, in the United States market, financial payment processing follows traditional product based routing. This means that payment is destined for a specific product silo prior to being received by a financial institution. Silo payment processing occurs prior to image capture and involves a series of linearly processed steps, in which the form of the received payment input is, in many instances, the same as the payment remittance/settlement. For example, if the payment is inputted electronically, the product silo outputs payment, in many instances, electronically. Thus, each payment type, such as paper, image, electronic, wire, Automated Clearing House (ACH) and the like, has its own product silo and the channel, and thus silo, is chosen prior to transaction submission. These individual product silos are not fully integrated and as such, operate autonomously as separate systems. In this regard, specific product silos require specific logic processing and processing hardware based on which payment type/product the silo is set-up to accommodate.

International payment systems differ somewhat in that the payments are destined for low value channels or high value channels but, similar to Unites States payment processing, payments are pre-dispositioned prior to transmission.

Neither domestic nor international payment systems account for the customer/payor and, in some instances, the payment-processing financial institution, in terms of cost efficiency, timeliness of payment or other payment factors. For example, while a customer may be unconcerned with how a payment is routed, they are typically concerned with the speed of which the payment is received by the payee. In most instances, the customer/payor will desire payment to be received by the payee as soon as possible, however, in some instances the payor may desire a lag-time in payment receipt by the payor to insure that sufficient funds exist in the designated payment account. In addition to timeliness, the customer/payor may be concerned with the quality or risk of the payment transaction, i.e., insuring that the payment is made at the designated time and destination and/or the costs incurred by the customer/payor in making the payment. From the financial institution standpoint, the financial institution is concerned with making the payment in the most cost-efficient manner, so to maximize their profitability, while taking into account the customer's needs in terms of timeliness and payment risk.

Therefore, a need exists to develop systems, method, computer program products and the like for processing financial payments more effectively and cost efficiently. The desired systems, methods, computer program products and the like should allow for processing all types of payment requests in a comprehensive payment processing system. Additionally, the desired systems, methods and computer program products should process payment requests in a highly efficient manner that cost effective to both the financial institution and the customer (i.e., payor and/or payee). Additionally, the desired systems, methods, computer program products and the like should allow for customers/payors to either predefine payment configuration or dynamically define payment configuration on a per-payment or per-payment file basis, so as to address the needs of the customer/payor in terms of payment timeliness, payment cost, payment quality and the like. In addition, desired systems, methods, computer program products and the like should allow for financial institution to make payment routing decisions that not only take into account the customer's/payor's needs and concerns, but also take into account the financial institutions concern of minimizing the costs related to each transaction. Moreover, by providing for methods, computer program products and the like that allow the customer/payor greater options in predetermined payment configuration and/or dynamically configuring payment on a per-payment basis, the financial institution can implement different price points in the payment process.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, devices, systems and computer program products are described herein that provide for improving foreign currency exchange processing of financial payment requests and, more specifically improving the bid/ask spread in foreign currency exchange so as to increase the profitability realized by the financial institution processing the payment. In accordance with embodiments herein disclosed, international financial payment requests that are processed in a comprehensive payment hub environment, which allows for payment requests from different payment input channels, are pooled together based on currency type and payment time requirements to provide the financial institution processing the payment better exchange rates.

According to one embodiment of the invention, a method for processing financial payments is defined. The method includes receiving a plurality of international financial payment requests from a plurality of different payment input channels. The international financial payment requires foreign currency exchange. The method further includes pooling, or otherwise grouping, the plurality of international financial payment requests based at least in part on currencies involved in the foreign currency exchange. The method further includes determining an optimal foreign currency exchange for each of the pooled plurality of international financial payment requests so as to maximize profitability of a financial institution processing the international payment requests and exchanging currency of the pooled plurality of international payment requests in accordance with the determined optimal foreign currency exchange. Additionally, the method includes providing payment for the plurality of international financial payment requests in the exchanged currency.

In one embodiment of the method, receiving the plurality of international financial payment requests further includes receiving a plurality of international payment requests wherein a plurality of the requests require present time payment processing. In such embodiments, pooling the plurality of international financial payment requests further includes pooling the plurality of international financial payments based at least in part on the requests requiring present time payment processing.

In another embodiment of the method, receiving the plurality of international financial payment requests further comprises receiving a plurality of international payment requests wherein a plurality of the requests require future payment processing, such as one-time-only future payments or recurring future payments. In such embodiments, pooling the plurality of international financial payment requests further includes pooling the plurality of international financial payments based at least in part on the requests requiring future payment processing.

In yet another embodiment of the method, receiving the plurality of international financial payment requests further includes receiving a plurality of international payment requests wherein a first plurality of the requests require immediate payment processing and a second plurality of requests require future payment processing. In such embodiments, pooling the plurality of international financial payment requests further includes pooling the plurality of international financial payments based at least in part on a predetermined time interval for processing the payment of the first plurality of the requests and a portion of the second plurality of the requests.

In additional embodiments of the method, determining an optimal foreign currency exchange further includes determining an optimal foreign currency exchange rate for each of the pooled plurality of international financial payment requests. While in other embodiments of the method, determining an optimal foreign currency exchange further includes determining an optimal point in time for the exchange to occur for each of the pooled plurality of international financial payment requests.

Other optional embodiments of the method include, determining payment routing for each of the plurality of international payment requests based on one or more routing rules and providing for financial payment to a payee via the determined payment route in the exchanged currency. In such embodiments, determining payment routing may further include determining the payment routing based on one or more routing rules, wherein the routing rules are associated with one or more of payment processing time, payment processing cost, payment processing risk, payment destination or remittance requirements. In one specific embodiment, the one or more routing rules are operable to determine a least-cost payment type that meets time requirements and risk requirements.

Such embodiments of the method may further include receiving at least one of one or more payor-defined payment attributes, one or more payee-defined payment attributes or one or more financial institution defined payment attributes. In such embodiments, determining the payment routing may further include applying one or more of the payor-defined payment attributes, the payee-defined payment attributes or the financial institution-defined payment attributes to the one or more routing rules to determine the payment routing.

An apparatus for processing financial payments provides for yet another embodiment of the invention. The apparatus includes a computing platform including at least one processor and a memory. Additionally, the apparatus includes a payment processing module, such as a payment hub, stored in the memory, executable by the processor and operable to receive a plurality of international financial payment requests from a plurality of different payment input channels and provide for payment of the requests in an exchanged currency, wherein the international payment requests require foreign currency exchange. The payment processing hub includes a foreign currency exchange sub-module. The foreign currency sub-module includes pooling logic operable to pool the plurality of international financial payment requests based at least in part on currencies involved in the foreign currency exchange. The sub-module additionally includes foreign currency exchange determination logic operable to determine an optimal foreign currency exchange for each of the pooled plurality of international financial payment requests so as to maximize profitability of a financial institution processing the international payment requests and a foreign currency exchange routine operable to exchange currency of the pooled plurality of international payment requests in accordance with the determined optimal foreign currency exchange.

In one embodiment of the apparatus, the payment processing module is further operable to receive the plurality of international payment requests wherein a plurality of the requests require present time payment processing. In such embodiments, the pooling logic may be further operable to pool the plurality of international financial payments based at least in part on the requests requiring present time payment processing. In another embodiment of the apparatus, the payment processing module is further operable to receive a plurality of international payment requests wherein a plurality of the requests require future payment processing. In such embodiments, pooling logic is further operable to pool the plurality of international financial payments based at least in part on the requests requiring future payment processing.

In yet another embodiment of the apparatus, the payment processing module is further operable to receive a plurality of international payment requests wherein a first plurality of the requests require immediate payment processing and a second plurality of requests require future payment processing. In such embodiments, the pooling logic may be further operable to pool the plurality of international financial payments based at least in part on a predetermined time interval for processing the payment of the first plurality of the requests and a portion of the second plurality of the requests.

In additional embodiments of the apparatus, the foreign currency exchange determination logic is further operable to determine an optimal foreign currency exchange rate for each of the pooled plurality of international financial payment requests. While in other embodiments of the apparatus, the foreign currency exchange determination logic is further operable to determine an optimal point in time for the exchange to occur for each of the pooled plurality of international financial payment requests.

In still further alternate embodiments of the apparatus, the payment processing module may further include a payment route determination sub-module operable to determine payment routing for each of the plurality of international payment requests based on one or more routing rules. In such embodiments, the payment route determination sub-module may be further operable to determine the payment routing based on one or more routing rules, wherein the routing rules are associated with one or more of payment processing time, payment processing cost, payment processing risk, payment destination or remittance requirements. In one specific embodiment, the one or more routing rules are operable to determine a least-cost payment type that meets time requirements and risk requirements.

In other related embodiments of the apparatus, the payment route determination sub-module is further operable to receive at least one of one or more payor-defined payment attributes, one or more payee-defined payment attributes or one or more financial institution defined payment attributes and apply one or more of the payor-defined payment attributes, the payee-defined payment attributes or the financial institution-defined payment attributes to the one or more routing rules to determine the payment routing.

A computer program product including a computer readable medium defines yet another embodiment of the invention. The medium includes a first set of codes for causing a computer to receive a plurality of international financial payment requests from a plurality of different payment input channels. The international payment requests require foreign currency exchange a financial payment request. The medium also includes a second set of codes for causing a computer to pool the plurality of international financial payment requests based at least in part on currencies involved in the foreign currency exchange and a third set of codes for causing a computer to determine an optimal foreign currency exchange for each of the pooled plurality of international financial payment requests so as to maximize profitability of a financial institution processing the international payment requests. Additionally, the medium includes a fourth set of codes for causing a computer to exchange currency of the pooled plurality of international payment requests in accordance with the determined optimal foreign currency exchange and a fifth set of codes for causing a computer to provide payment for the plurality of international financial payment requests in the exchanged currency.

Thus, methods, devices, systems and computer program products described herein provide for improving foreign currency exchange processing of financial payment requests and, more specifically improving the bid/ask spread in foreign currency exchange so as to increase the profitability realized by the financial institution processing the payment. In accordance with embodiments herein disclosed, international financial payment requests that are processed in a comprehensive payment hub environment, which allows for payment requests from different payment input channels, are pooled together based on currency type and payment time requirements to provide the financial institution processing the payment better exchange rates.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of an apparatus configured to provide improved foreign currency exchange in a payment hub environment, in accordance with one embodiment of the present invention;

FIG. 2 is a more detailed block diagram of the apparatus configured to provide improved foreign currency exchange in a payment hub environment, in accordance with one embodiment of the present invention;

FIG. 3 is flow diagram of a method for processing financial payment requests, in accordance with an embodiment of the present invention;

FIG. 4 is a block diagram of financial payment input channels; in accordance with an embodiment of the present invention;

FIG. 5 is a block diagram of payment arrangement attribute/criteria sources, in accordance with another embodiment of the present invention;

FIG. 6 is a block diagram of specific payment processes, including optional processes, in accordance with an embodiment of the present invention;

FIG. 7 is a block diagram of payment validation processes, in accordance with an embodiment of the present invention;

FIG. 8 is a block diagram of examples of routing rules, in accordance with an embodiment of the present invention;

FIG. 9 is a block diagram of remittance and settlement channels, in accordance with another embodiment of the present invention; and

FIG. 10 is a block diagram of a flow diagram of a method for providing foreign currency exchange in a payment hub environment, according to a yet another embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems or apparatus that may include a number of devices, components, modules, and the like. It is to be understood and appreciated that the various systems or apparatus may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer program products and the like are described herein that provide for improving foreign currency exchange processing of financial payment requests and, more specifically improving the bid/ask spread in foreign currency exchange so as to increase the profitability realized by the financial institution processing the payment. In accordance with embodiments herein disclosed, international financial payment requests that are processed in a comprehensive payment hub environment, which allows for payment requests from different payment input channels, are pooled together based on currency type and payment time requirements to provide the financial institution processing the payment better exchange rates.

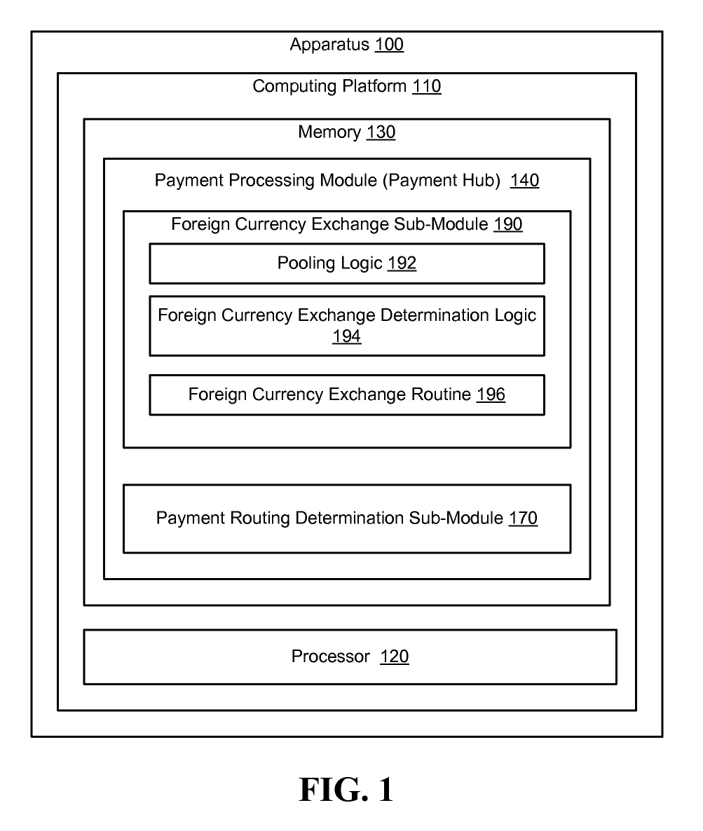

Referring to FIG. 1 a block diagram is depicted of an apparatus 100 configured to provide financial payment processing, according to embodiments of the present invention. As previously noted apparatus 100 may include one or multiple devices. In multiple device embodiments, the devices may be in networked communication with one another. Apparatus 100 includes a computing platform 110 having at least one processor 120 and a memory 130.

Memory 130 of apparatus 100 includes a payment processing module 140, also referred to herein as a payment hub, which includes a plurality of payment process sub-modules. In accordance with embodiments herein disclosed, the payment processing module 140 is a comprehensive payment processing system capable of processing payments irrespective of the payment input channel. In one embodiment of the invention, the capability to process payment requests irrespective of the payment input channel is provided for by transforming the initial format of the payment request to a standardized or normalized format.

The payment processing sub modules may include, but are not limited to, modules capable of providing payment route determination, scheduling of future and/or recurring payments, correlation of debits and credits, payment verification, bulk payment processing, payment data storage, payment compliance checks, foreign exchange processing, payment risk assessment, payment exception handling and the like. Each payment sub-module may include one or more payment processes that may be required or otherwise executed as part of a payment request.

According to embodiments herein described, the payment processing module 140 may include a foreign currency exchange sub-module 190 that is operable to provide for currency exchange in international payment requests that require such. In accordance with present embodiments, the foreign currency exchange sub-module 190 may include pooling logic 192 that is operable to pool or group the international payment requests based on currencies involved in the exchange and the timing of the payment transaction. Pooling may take into account payments requiring immediate payment and future scheduled payments, such as one-time only future payments and recurring future payments, being executed through the payment processing module 140. The pooling of financial payment requests requiring currency exchange may provide for better exchange rates for the financial institution handling the transactions based on current or near-term exchange rates and the volume of the transactions. In addition, pooling of transactions may account for minimal net settlement balances in instances in which currency exchanges in one direction can be offset with other currency exchanges in the opposite direction.

The foreign currency exchange sub-module 190 additionally includes foreign currency exchange determination logic 194 operable to determine an optimal foreign exchange for the pools of international payment requests based on current exchange rates, trends in the exchange rates and/or the timing required to satisfy payment of the pool of international payment requests. Additionally, the foreign currency exchange sub-module 190 includes foreign currency exchange routine 196 operable to execute the foreign currency exchange based on the determined optimal foreign currency exchange.

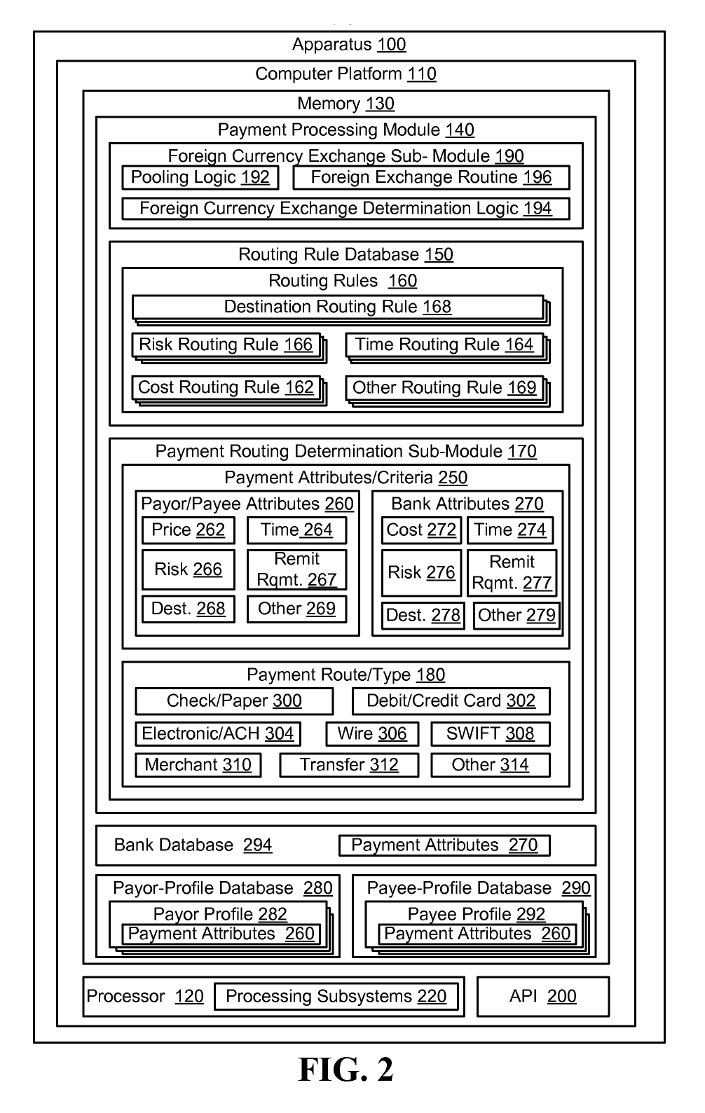

According to certain embodiments, the payment processing module 140 may additionally include a payment routing determination sub-module 170 that is operable to determine the payment route (i.e., output payment channel) for a payment request based on one or more predefined payment routing rules. FIG. 2 and the related discussion provides for more details pertaining to the payment routing determination sub-module 170.

FIG. 2 provides a more detailed depiction of the apparatus 100, according to further embodiments of the present invention. In addition to providing greater detail, FIG. 2 highlights various optional embodiments. The apparatus 100 may include any type and/or combination of one or more computing devices, such as a personal computer, a laptop/portable computer, a wireless or handheld computing device, a server or the like. The computer platform 110 is operable to receive and execute modules, routines and applications, such as payment processing module 140 and the like. Computer platform 110 includes memory 130, which may comprise volatile and nonvolatile memory such as read-only and/or random-access memory (RAM and ROM), EPROM, EEPROM, flash cards, or any memory common to computer platforms. Further, memory 130 may include one or more flash memory cells, or may be any secondary or tertiary storage device, such as magnetic media, optical media, tape, or soft or hard disk.

Further, computer platform 110 also includes processor 120, which may be an application-specific integrated circuit (“ASIC”), or other chipset, processor, logic circuit, or other data processing device. Processor 120 or other processor such as ASIC may execute an application programming interface (“API”) layer 200 that interfaces with any resident programs, such as payment processing module 140, or the like, stored in the memory 130 of apparatus 100.

Processor 120 includes various processing subsystems 220 embodied in hardware, firmware, software, and combinations thereof, that enable the functionality of apparatus 100 and the operability of the apparatus on a network. For example, processing subsystems 220 allow for initiating and maintaining communications, and exchanging data, with other networked devices.

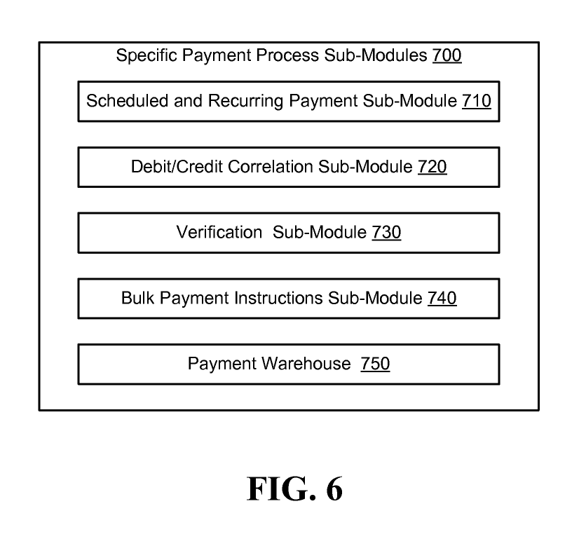

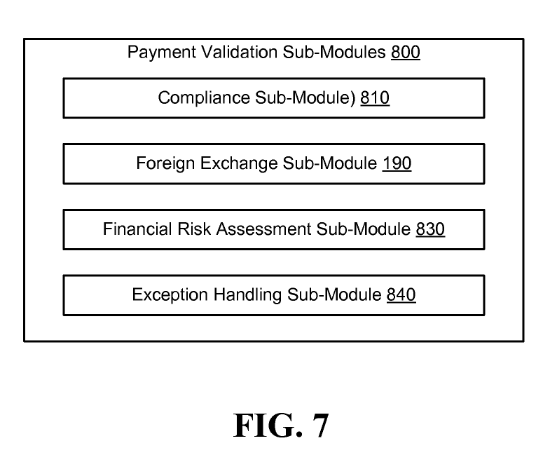

As previously noted, the memory 130 of apparatus 130 includes payment processing module 140. In accordance with present embodiments, the payment processing module 140 includes, amongst other sub-modules discussed infra. in relation to FIGS. 6 and 7, a foreign currency exchange sub-module 190. The foreign currency exchange sub-module includes polling logic 192, foreign currency exchange determination logic 194 and foreign currency exchange routine 196. The pooling logic 192 that is operable to pool or group the international payment requests based on currencies involved in the exchange and the timing of the payment transaction. The foreign currency exchange determination logic 194 operable to determine an optimal foreign exchange for the pools of international payment requests based on current exchange rates, trends in the exchange rates and/or the timing required to satisfy payment of the pool of international payment requests. The foreign currency exchange routine 196 operable to execute the foreign currency exchange based on the determined optimal foreign currency exchange.

The payment processing module 140 is operable to receive payment instructions, validate the payment and determine routing for the payment. In accordance with present embodiments of the invention, the payment processing module 140 is operable to determine payment routing on a per payment-basis, such that the manner in which payment is remitted and settled may be determined based on characteristics related to the payment and/or payor, and/or payee and/or the financial institution handling the payment. In this regard, payment optimization is realized by the payor, the payee and/or the financial institution in terms of cost of payment processing, timeliness of payment processing and the quality/risk of the payment process.

Similar to FIG. 1, single modules are illustrated and described for payment processing module 140, however, in accordance with present embodiments, the modules may comprise multiple modules and the multiple modules may be included within various different apparatus. Thus, the sub-modules, routines, applications, databases and logic described in relation payment processing module 140 may be included within multiple modules. Likewise, the rules and logic discussed in relation to payment processing module 140 may be included or implemented in multiple devices, applications or routines.

Payment processing module 140 includes routing rule database 150 routing rules database 150 that includes one or more routing rules 160. The routing rules 160 may be related to payment routing factors such as, but not limited to, price/cost of processing payment, time requirements for processing the payment, the quality/risk requirements or allowances for processing the payment (i.e., the guarantee of remittance and settlement, the ability to stop payment and the like), the destination of the payment and the like. Thus, the routing rules 160 may include one or more cost/price-related routing rules 162, one or more time-related routing rules 164, one or more risk/quality-related routing rules 166, one or more destination-related routing rules 168 or other routing rules 169.

Cost/price-related routing rules 162 may define which remittance/settlement type 180 is chosen based on the price that the payor and/or payee is willing to bear for the payment being made or the cost that the financial institution is willing to bear or likely to charge the payor for handling the payment. In this regard, different remittance settlement types may be associated with different payment prices, such that, payment by one remittance/settlement type may be higher or lower in terms payment price than another remittance/settlement type.

Time-related routing rules 164 may define which remittance/settlement type 180 is chosen based on the payor's, payee's and/or the financial institution's acceptable time for completing the payment transaction. In most instances, the payor and/or payee has a desire to complete the payment as timely as possible, while the financial institution handling the payment has a desire to delay the remittance/settlement for as long a time period as possible. However, it should be noted that while in most instances the payor is concerned with making the payment as timely as possible in other instances the payor may desire to delay the time for payment, for example, if insufficient funds currently exist in the account from which the payment is being made.

Risk/Quality-related routing rules 166 may define which remittance/settlement type 180 is chosen based on the ability to insure or guarantee that the payment will be made, in other words, the service level afforded to the payment or the number of failure opportunities associated with different payment remittance/settlement types. Other risk/quality routing rules 166 may define the ability to return or stop payment during the payment process, data reconciliation capabilities, such as how funds are balanced, or any other routing rule associated with a quality or risk attribute as defined by the payor, the payee and/or the financial institution handling the payment process.

Destination-related routing rules 168 may define which remittance/settlement type 180 is chosen based the destination of the payment. For example, domestic payment may dictate certain types of remittance/settlement, while international payment may dictate other types of remittance/settlement.

Other routing rules 169 may additionally define other criteria for choosing the remittance/settlement type 180. Other routing rules may be dictated by the needs of the financial institution handling the payment process, the payor and/or the payee.

Payment processing module 140 additionally includes payment routing determination logic 170 that is executable by the processor 120 and is operable to determine payment routing (i.e., a payment type 180, otherwise referred to herein as a payment route) for a payment transaction from amongst more than one alternative payment types based on application of one or more of the routing rules. In instances in which more than one routing rule is applied to determine the remittance settlement type 180, the payment routing determination logic 170 may be operable to determine priority of the routing rules and/or make the appropriate routing determination that insures that the payor/payee and/or financial institution handling the payment process needs are met.

The payment routing determination logic 170 is operable to apply one or more payment attributes/payment criteria 250 to the one or more routing rules 160 to determine the payment route/type 180. The payment attributes may be payor-defined/payee-defined payment attributes 260 and/or financial institution/bank-defined payment attributes 270. The payor-defined/payee-defined payment attributes 260 may include, but are not limited to, price 262, time 264, risk/quality 266, remittance requirements, 267, destination 268 or any other appropriate attribute 269 that may be applied to a routing rule. The financial institution/bank-defined payment attributes 270 may include, but are not limited to, cost 272, time 274, risk/quality 276, remittance requirements 277, destination 278 or any other appropriate attribute 279 that may be applied to a routing rule.

The payment attributes/criteria 250 may be dynamically defined at the time of the payment request by the payor, the payee or the financial institution or the payment attributes/criteria 250 may be predefined attributes associated with the payor, the payee and/or financial institution. Additionally, in certain embodiments, payment attributes/criteria may be defined dynamically be the payor, payee and/or financial institution during the payment process. Thus, memory 130 may include, or the payment module may be in communication with another auxiliary device's memory (not shown in FIG. 2) that includes, payor-profile database 280, payee-profile database 290 and/or financial institution/bank database 294 operable for storing payment attributes/criteria. Thus, payor-profile database 280 may include a plurality of payor/customer profiles 282 and each profile 282 includes payment attributes/criteria 260 associated with the payor. Payee-profile database 290 may include a plurality of payee profiles 292 and each profile 292 includes payment attributes/criteria 260 associated with the payee. The financial institution/bank database 294 may include payment attributes/criteria 270 associated with an input payment request type or any other relevant association.

As previously noted, the payment routing determination logic 170 may determine any appropriate payment route 180 type from among more than one alternative. The payment route/type may include check/paper 300, credit/debit card 302, electronic/ACH 304, wire 306, SWIFT 308, merchant 310, account transfer 312 or ant other 314 remittance/settlement payment route/type. An alternative payment route comprises two or more of the payment route-types. For example, check/paper 300 or credit/debit 302 comprises one alternative payment route, SWIFT 308 or account transfer 312 comprises another alternative payment route and wire 306 or SWIFT 308 or merchant 310 comprises another alternative payment route.

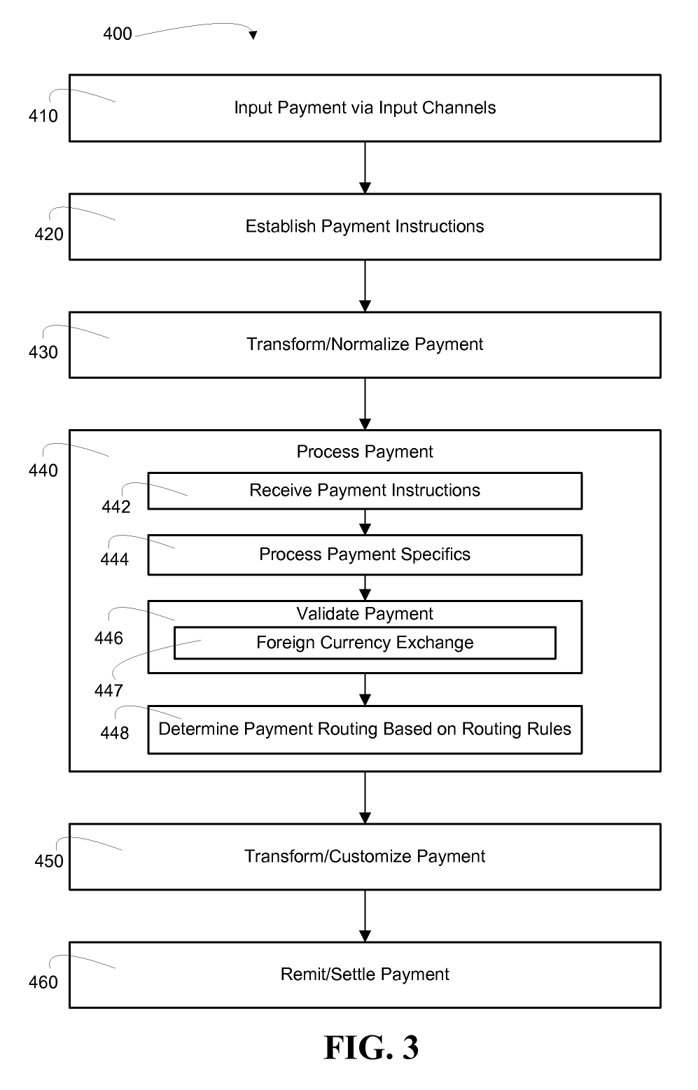

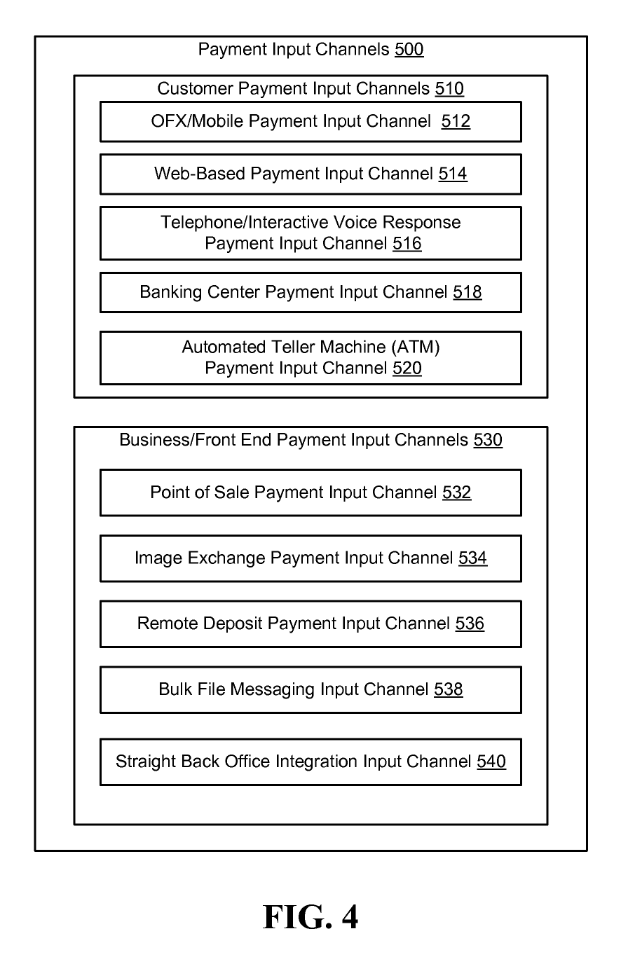

FIG. 3 provides a flow diagram of a composite method 400 for payment processing including rules-based determination of payment routing, in accordance with an embodiment of the present invention. At Event 410, a payment request is inputted via a designated input channel. FIG. 4 provides a block diagram of various examples of payment input channels 500. It should be noted that the payment input channels 500 shown in FIG. 4 are by of example only and are not intended to be limiting. The payment input channels 500 may include customer payment input channels 510 and business/front end payment input channels 530. The customer payment input channels 510 provide for customer-to-business payment inputs and/or customer-to-consumer (i.e., consumer-to-consumer) payment inputs. The business/front end payment input channels 530 provide for business-to-business payment inputs and/or business-to-consumer payment inputs.

The customer payment input channels are user interface's and may include, but are not limited to, Open Financial Exchange(OFX)/Mobile payment input channel 512, generally operable on handheld devices and the like; web-based payment input channel 514, such as the Internet or a corporate website that is generally operable to receive Automated Clearing House (ACH) requests, wire payment requests, bill payment and the like; telephone/Interactive Voice Response (IVR) payment input channel 516; banking center payment input channel (in person) 518; and Automated Teller Machine (ATM) payment input channel 520.

The business/front end input channels 530 include, but are not limited to, point-of-sale payment input channel 532, such as credit/debit card swipe or the like; image exchange payment input channel 534; remote deposit payment input channel 536; bulk file messaging payment input channel 538; and straight back office integration input channel 540, in which a business application directly calls/accesses a financial institution payment engine to originate a transaction.

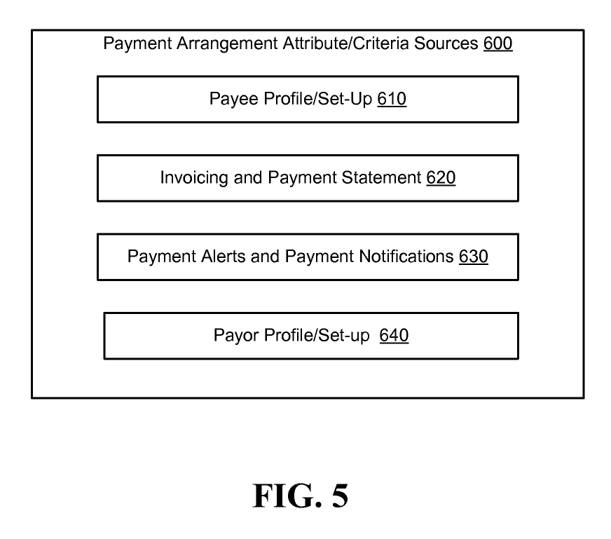

Referring again to the method 400 of FIG. 3, at Event 420, payment arrangement attributes/criteria are established. The payment arrangement attributes/criteria are configurable data that is associated with a consumer payor/payee or a corporate payor/payee and is subsequently used by the payment processing hub to process various aspects of the payment request. FIG. 5 provides a block diagram of various examples of payment arrangement criteria/attribute sources 600. The sources 600 may include, but are not limited to, payee profile/set-up 610. Payee profile/set-up 610 may be a dynamic set-up for a specific payment that the payee is to receive. For example, the payee receives notification that a payment is forthcoming and through an appropriate designated channel, such as a website or the like, the payee configures payment attributes/criteria, such as the time requirements for the payment or the like. Alternatively, the payee may have a predetermined payment profile, which may be stored in an accessible payee profile database that predefines payment attributes/criteria.

The payment arrangement criteria/attribute sources 600 may additionally include invoicing and payment statements 620 issued by the payor and/or payee that define payment arrangement attributes/criteria for a specific payment or a series of payments, such as payment risk/quality, payment destination and the like. Sources 600 may additionally include payment alerts and/or payment notifications 630 that are generally associated with a specific payment or a series of payments and define payment arrangement criteria specifically designated by the payor, the payee or the financial institution handing the payment transaction.

The payment arrangement criteria/attribute sources 600 may include payor profile/set-up 640. Payor profile/set-up 640 may be a dynamic set-up for a specific payment that the payor has requested. Alternatively, the payor may have a predetermined payment profile, which may be stored in an accessible payor profile database that predefines payment attributes/criteria.

Referring again to the method 400 of FIG. 3, at Event 430, the payment request is transformed, otherwise referred to as normalized, to a standard format to allow for processing of all different payments regardless of input channels. As previously noted, according to specific embodiments, the standardized format may be in accordance with ISO 20022 Universal Financial Industry Message Scheme format. In conventional, known payment processing each payment input channel requires a dedicated silo for processing the payment. In accordance with present embodiments, transformation to a standard format allows for comprehensive payment processing to occur generically regardless of the type of payment input channel.

At Event 440, payment processing occurs at what is referred to herein as the payment processing module or payment hub. Based on the transformation/normalization of the payment request, the payment hub is capable of processing all types of payment input requests. It should be noted that while the events (Events 442, 444 and 446) shown in payment processing block occur in sequential order, according to present embodiments, the events may occur in any sequential or serially order, as determined by the payment hub, in order to optimize the payment process.

It should be noted that the routines, modules, applications and functions shown in relation to Event 440 and described herein as occurring in the payment engine may be accessed and implemented by other applications, such as other payment processing applications that do not implement the payment engine or the like. In this regard, other applications may access the specific routines, modules, applications and functions on an as-needed basis. For example, if another payment processing application requires payment validation in the form of compliance to anti-money laundering laws, the application can access and implement that specific portion of the payment hub as opposed to implementing the multiple applications in the payment hub or the payment hub in its entirety.

Payment processing may include, at Event 442, receiving the payment instructions, such as payment attributes/criteria, invoicing/statements, alerts, notifications and the like, which are used to make payment processing decisions.

At Event 444, specific payment processing occurs within one or sub-modules based on the payment type being made. FIG. 6 is a block diagram detailing various exemplary specific payment process sub-module 700 that may be implemented at the payment hub, in accordance with embodiments of the present invention. It should be noted that the specific payment process sub-modules 700 highlighted in FIG. 6 are by way of example only and are not intended to be limiting. In addition, the ordering of the payment processing may be determined at the payment hub, in some embodiments on a per-payment basis, to increase the overall efficiency and effectiveness of the payment processing model.

Specific payment process sub-modules 700 may include scheduled and recurring payment sub-module 710. The scheduled and recurring payment sub-module 710 manages the initiation of future dated and recurring payments, including the use of predefined custom templates set-up for the scheduled/recurring payments. Additionally, specific payment process sub-modules 700 may include debit/credit correlation sub-module 720 that includes timing and sequencing processing to insure the relationship of the original payment association. In this regard, individual credits are associated and balanced to original debit when processed at a payment item level.

The specific payment process sub-modules 700 may also include verification sub-module 730 operable to verify the payment and associated account attributes to insure positive clearing of the payment. Additionally, specific payment process sub-modules 700 may include bulk payment sub-module 740 that is operable to aggregate and optimize communications to external systems for large payment files having multiple individual payment items with multiple payment items having the same posting accounts. Also, specific payment process sub-module 700 may include payment warehouse/database 750 that is operable to store future dated payments, payment history, recurring payment models and the like.

Referring again to the method 400 of FIG. 3, payment processing (Event 440) may also include validation processing 446 of the payment. The validation processing may include foreign currency exchange processing 447 as illustrated in FIG. 3. FIG. 7 is a block diagram detailing various exemplary validation process sub-modules 800 that may be implemented at the payment hub, in accordance with embodiments of the present invention. It should be noted that the specific validation process sub-modules 800 highlighted in FIG. 7 are by way of example only and are not intended to be limiting. In addition, the ordering of the validation processing may be determined at the payment hub, in some embodiments on a per-payment basis, to increase the overall efficiency and effectiveness of the payment processing model.

Validation process sub-modules 800 may include compliance process sub-module 810 operable to insure anti-money laundering of the payment. Compliance processing may include a security check of Office of Foreign Asset Control (OFAC) listing of known individuals, corporations or the like associated with illegal payment processing. Additionally, validation process sub-modules 800 may include foreign exchange/Single European Payments Area (SEPA) sub-module 190 operable to maximize foreign currency exchange rates, provide for multi-currency support and insure compliance with SEPA rules and regulations.

In addition, validation process sub-modules 800 may include financial risk assessment sub-module 830 operable to provide credit and risk management for the overall payment process. In this regard, the financial risk assessment process may provide for liability risk assessment scores and the like that are subsequently used by the rules-based routing determination to limit or mandate the type of remittance/settlement route that may be implemented. For example, if the financial risk is determined to be high, route determination may exclude wire payments as a remittance/settlement payment option.

Also, validation process sub-modules 800 may include exception handling sub-module 840 operable to provide centralized exception processing and management of all payment types. Exception processing takes into account errors in the payment processing, such as formatting error or the like and may implement an auto repair for common exceptions/errors. Auto repair of exceptions provides for less need for manual intervention and improves straight-through payment processing rates.

Referring again to the method 400 of FIG. 3, at optional Event 447, based on an outcome of payment process conducted at Event 446, payment processing adjustments may be made that may include adding or deleting a payment process or modifying/re-arranging the order or flow of the payment processes.

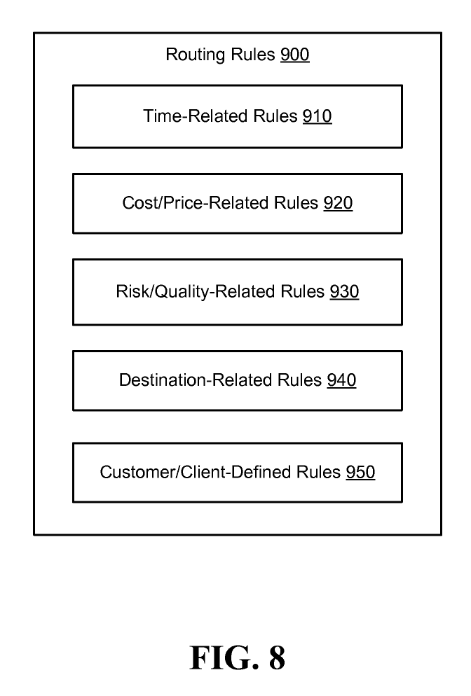

Payment processing (Event 440) may also include rules-based route determination processing 448. FIG. 8 provides a block diagram of exemplary routing rules 900 that may be implemented in a payment route determination process, in accordance with an embodiment of the present invention. The routing rules illustrated are by way of example only. It should be noted that for any one route determination process one or more of the routing rules may be applied. Priority given to one or more of the rules may be based on payor profile data, payee profile data, notifications, alerts, financial institution rules, and the like. The routing rules 900 may be related to payment routing factors such as, but not limited to, price/cost of processing payment, time requirements for processing the payment, the quality/risk requirements or allowances for processing the payment (i.e., the guarantee of remittance and settlement, the ability to stop payment and the like), the destination of the payment and the like. Thus, the routing rules 900 may include one or more time-related rules 910, cost/price-related routing rules 920, one or more risk/quality-related routing rules 930, one or more destination-related routing rules 940 or other payor/payee defined routing rules 950.

As previously noted, time-related routing rules 910 may define which remittance/settlement type 180 is chosen based on the payor's, payee's and/or the financial institution's acceptable time for completing the payment transaction. In most instances, the payor and/or payee has a desire to complete the payment as timely as possible, while the financial institution handling the payment has a desire to delay the remittance/settlement for as long a time period as possible. Cost/price-related routing rules 920 may define which remittance/settlement type 180 is chosen based on the price that the payor and/or payee is willing to bear for the payment or the cost that the financial institution is willing to bear or likely to charge the payor for handling the payment.

Risk/quality-related routing rules 930 may define which remittance/settlement type 180 is chosen based on the ability to insure or guarantee that the payment will be made, in other words, the service level afforded to the payment or the number of acceptable failure opportunities associated with different payment remittance/settlement types. Other risk/quality routing rules 166 may define the ability to return or stop payment during the payment process, data reconciliation capabilities, such as how funds are balanced, or any other routing rule associated with a quality or risk attribute as defined by the payor, the payee and/or the financial institution handling the payment process. Destination-related routing rules 940 may define which remittance/settlement type 180 is chosen based the destination of the payment. For example, domestic payment may dictate certain types of remittance/settlement, while international payment may dictate other types of remittance/settlement.

Payor/payee-defined rules 950 may additionally define other criteria for choosing the remittance/settlement type. Payor/payee-defined routing rules 950 may be dynamically defined proximate to the time of the payment request or may be predefined in the payor or payee profile. In most instances, payor or payee-defined routing rules will override any other routing rules.

Referring once again to the method 400 of FIG. 3, payment processing may include other processing (not shown in FIG. 3) such as remittance reporting, Business Process Management (BPM) orchestration, transaction tracking/visibility and the like. Remittance reporting provides electronic reporting of the remittance to associated services; examples of remittance reporting include, but are not limited to, Demand Deposit Account (DDA) statements, account reconciliation reporting, balance and transaction reporting and the like. BPM orchestration is operable to determine the order in which processes are taken up in the payment hub, determine and manage the delivery of information to the payment warehouse and the like. The order in which processes are taken up may be determined based on payment input channel, payment attributes/criteria or the determined payment route. Thus, BPM orchestration provides a set of tools for efficiently aligning payment processing. Transaction/tracking visibility allows the payor, payee or any other individual or corporate entity with designated access to view where the payment currently resides in the overall process payment flow. Transaction/tracking visibility is typically implemented through an online user interface, such as a web-based interface or the like.

At Event 450, in accordance with present embodiments, the normalized and processed payment is transformed to the remittance/settlement target clearing format. Transformation to the target clearing format is dictated by the initial normalization of the payment request to a standardized format. In addition, transformation to the target clearing format provides for payment remittance via the payment channel determined at payment route determination processing.

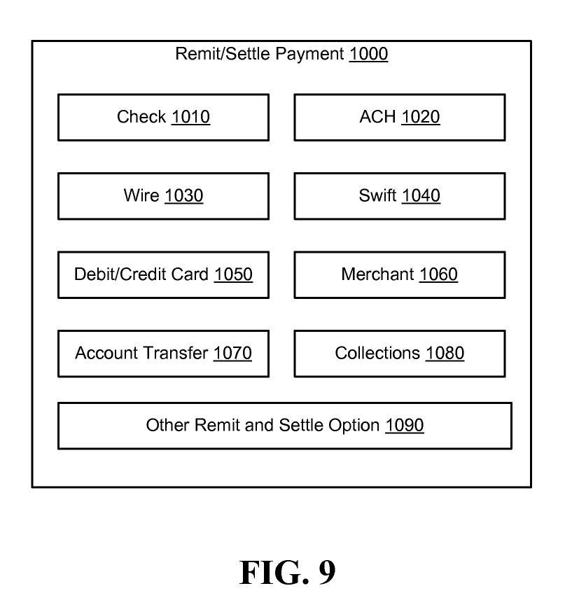

At Event 460, payment is remitted and settled according to the determined payment route. FIG. 9 provides a block diagram of exemplary remittance/settlement payment channels 1000, in accordance with embodiment of the present invention. The remittance payment channels 1000 may include, but are not limited to, check payment 1010, Automated Clearing House (i.e., electronic) payment 1020, wire payment 1030, Society for Worldwide International Financial Telecommunication (SWIFT) payment 1040, debit/credit card payment 1050, merchant payment 1060, and account transfer payment 1070 and settlement channels may include collections 1070 or the like. Additionally, other remittance/settlement payment channel options 1090 may be implemented, such as to take into account future known settlement and remittance options.

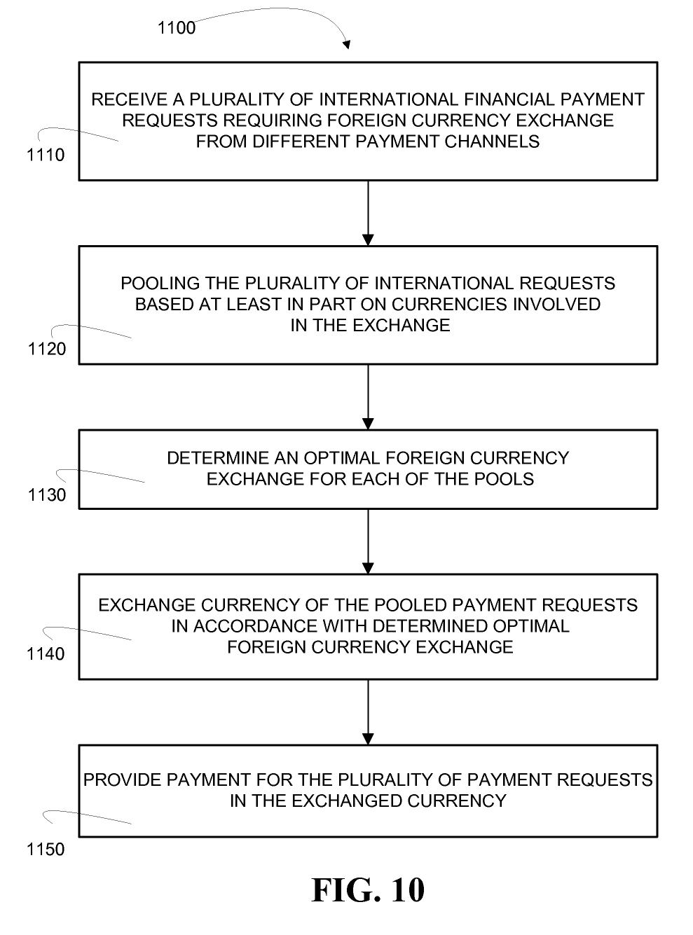

Referring to FIG. 10 a flow diagram is illustrated of a method 1100 for financial payment processing including foreign currency exchange, in accordance with embodiment of the present invention. At Event 1110, a plurality of international financial payment requests are received at the payment hub. In accordance with payment hub processing, the payment requests may be inputted using any known or future known payment input channel. Examples of payment input channels include, but are not limited to, Open Financial Exchange (OFX)/mobile, web-based, Interactive Voice Response (IVR)/telephone, banking center, Automated Teller Machine (ATM), debit/credit card, merchant, check, image, wire, Automated Clearing House (ACH) or the like.

At Event 1120, the plurality of international payment requests may be pooled, or otherwise grouped based on currency type, requirements related to the timing of payments and any other suitable payment attribute.

At Event 1130, optimal foreign currency exchange is determined for each of the pools based on current exchange rates, exchange rate trends, payment timing requirements and any other factors. The optimal foreign currency exchange may provide for an improved exchange rate for the financial institution processing the payment.

At Event 1140, the currency exchange occurs based on the determined optimal foreign exchange and, at Event 1150, the financial payment is provided to the pay via a determined payment route and in the requisite foreign currency.

Thus, methods, devices, systems and computer program products described herein provide for improving foreign currency exchange processing of financial payment requests and, more specifically improving the bid/ask spread in foreign currency exchange so as to increase the profitability realized by the financial institution processing the payment. In accordance with embodiments herein disclosed, international financial payment requests that are processed in a comprehensive payment hub environment, which allows for payment requests from different payment input channels, are pooled together based on currency type and payment time requirements to provide the financial institution processing the payment better exchange rates.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for processing financial payments, the method comprising:
receiving a plurality of international financial payment requests from a plurality of different payment input channels, wherein the international payment requests require foreign currency exchange;
pooling the plurality of international financial payment requests based at least in part on currencies involved in the foreign currency exchange;
determining an optimal foreign currency exchange for each of the pooled plurality of international financial payment requests so as to maximize profitability of a financial institution processing the international payment requests;
exchanging currency of the pooled plurality of international payment requests in accordance with the determined optimal foreign currency exchange; and
providing payment for the plurality of international financial payment requests in the exchanged currency.

2. The method of claim 1, wherein receiving the plurality of international financial payment requests further comprises receiving a plurality of international payment requests wherein a plurality of the requests require present time payment processing.

3. The method of claim 2, wherein pooling the plurality of international financial payment requests further comprises pooling the plurality of international financial payments based at least in part on the requests requiring present time payment processing.

4. The method of claim 1, wherein receiving the plurality of international financial payment requests further comprises receiving a plurality of international payment requests, wherein a plurality of the requests require future payment processing.

5. The method of claim 4, wherein receiving a plurality of international payment requests wherein a plurality of the requests require future payment processing further defines future payment processing as at least one of one-time only future payments or recurring payments.

6. The method of claim 4, wherein pooling the plurality of international financial payment requests further comprises pooling the plurality of international financial payments based at least in part on the requests requiring future payment processing.

7. The method of claim 1, wherein receiving the plurality of international financial payment requests further comprises receiving a plurality of international payment requests, wherein a first plurality of the requests require immediate payment processing and a second plurality of requests require future payment processing.

8. The method of claim 7, wherein pooling the plurality of international financial payment requests further comprises pooling the plurality of international financial payments based at least in part on a predetermined time interval for processing the payment of the first plurality of the requests and a portion of the second plurality of the requests.

9. The method of claim 1, wherein determining an optimal foreign currency exchange further comprises determining an optimal foreign currency exchange rate for each of the pooled plurality of international financial payment requests.

10. The method of claim 1, wherein determining an optimal foreign currency exchange further comprises determining an optimal point in time for the exchange to occur for each of the pooled plurality of international financial payment requests.

11. The method of claim 1, further comprising determining payment routing for each of the plurality of international payment requests based on one or more routing rules and providing for financial payment to a payee via the determined payment route in the exchanged currency.

12. The method of claim 11, wherein determining payment routing further comprises determining the payment routing based on one or more routing rules, wherein the routing rules are associated with one or more of payment processing time, payment processing cost, payment processing risk, payment destination or remittance requirements.

13. The method of claim 11, wherein determining payment routing further comprises determining the payment routing based on one or more routing rules, wherein the one or more routing rules are operable to determine a least-cost payment type that meets time requirements and risk requirements.

14. The method of claim 11, further comprising receiving at least one of one or more payor-defined payment attributes, one or more payee-defined payment attributes or one or more financial institution-defined payment attributes and wherein determining the payment routing further comprises applying one or more of the payor-defined payment attributes, the payee-defined payment attributes or the financial institution-defined payment attributes to the one or more routing rules to determine the payment routing.

15. The method of claim 14, wherein receiving at least one of one or more payor-defined payment attributes, one or more payee-defined payment attributes or one or more financial institution-defined payment attributes further comprises receiving the one or more payor-defined payment attributes, one or more payee-defined payment attributes or one or more financial institution-defined payment attributes, wherein each attribute is further defined as being related to at least one of time of payment, cost of payment, payment risk, remittance requirements or destination of payment.

16. The method of claim 14, wherein receiving at least one of one or more payor-defined payment attributes, one or more payee-defined payment attributes or one or more financial institution-defined payment attributes further comprises accessing at least one of a payor profile database, a payee profile database or a financial institution database to retrieve the one or more payor-defined payment attributes, one or more payee-defined payment attributes or one or more financial institution-defined payment attributes.

17. The method of claim 14, wherein receiving at least one of payor-defined payment attributes, one or more payee-defined payment attributes or one or more financial institution-defined payment attributes further comprises receiving the one or more payor-defined payment attributes, one or more payee-defined payment attributes or one or more financial institution-defined payment attributes, wherein the attributes are defined by the payor, payee or the financial institution at or near an inception of the financial payment request.

18. An apparatus for processing financial payments, the apparatus comprising:
a computing platform including at least one processor and a memory; and
a payment processing module stored in the memory, executable by the processor and operable to receive a plurality of international financial payment requests from a plurality of different payment input channels and provide for payment of the requests in an exchanged currency, wherein the international payment requests require foreign currency exchange, wherein the payment processing module includes,
a foreign currency exchange sub-module including,
pooling logic operable to pool the plurality of international financial payment requests based at least in part on currencies involved in the foreign currency exchange,
foreign currency exchange determination logic operable to determine an optimal foreign currency exchange for each of the pooled plurality of international financial payment requests so as to maximize profitability of a financial institution processing the international payment requests, and
a foreign currency exchange routine operable to exchange currency of the pooled plurality of international payment requests in accordance with the determined optimal foreign currency exchange.

19. The apparatus of claim 18, wherein the payment processing module is further operable to receive the plurality of international payment requests wherein a plurality of the requests require present time payment processing.

20. The apparatus of claim 19, wherein the pooling logic is further operable to pool the plurality of international financial payments based at least in part on the requests requiring present time payment processing.

21. The apparatus of claim 18, wherein the payment processing module is further operable to receive a plurality of international payment requests wherein a plurality of the requests require future payment processing.

22. The apparatus of claim 21, wherein the payment processing module is further operable to receive the plurality of international payment requests, wherein a plurality of the requests require future payment processing and wherein future payment processing is defined as at least one of one-time only future payments or recurring payments.

23. The apparatus of claim 21, wherein the pooling logic is further operable to pool the plurality of international financial payments based at least in part on the requests requiring future payment processing.

24. The apparatus of claim 18, wherein the payment processing module is further operable to receive a plurality of international payment requests wherein a first plurality of the requests require immediate payment processing and a second plurality of requests require future payment processing.

25. The apparatus of claim 24, wherein the pooling logic is further operable to pool the plurality of international financial payments based at least in part on a predetermined time interval for processing the payment of the first plurality of the requests and a portion of the second plurality of the requests.

26. The apparatus of claim 18, wherein the foreign currency exchange determination logic is further operable to determine an optimal foreign currency exchange rate for each of the pooled plurality of international financial payment requests.

27. The apparatus of claim 18, wherein the foreign currency exchange determination logic is further operable to determine an optimal point in time for the exchange to occur for each of the pooled plurality of international financial payment requests.

28. The apparatus of claim 18, wherein the payment processing module further comprises a payment route determination sub-module operable to determine payment routing for each of the plurality of international payment requests based on one or more routing rules.

29. The apparatus of claim 28, wherein the payment route determination sub-module is further operable to determine the payment routing based on one or more routing rules, wherein the routing rules are associated with one or more of payment processing time, payment processing cost, payment processing risk, payment destination or remittance requirements.

30. The apparatus of claim 28, wherein the payment route determination sub-module is further operable to determine the payment routing based on one or more routing rules, wherein the one or more routing rules are operable to determine a least-cost payment type that meets time requirements and risk requirements.

31. The apparatus of claim 28, wherein the payment route determination sub-module is further operable to receive at least one of one or more payor-defined payment attributes, one or more payee-defined payment attributes or one or more financial institution-defined payment attributes and apply one or more of the payor-defined payment attributes, the payee-defined payment attributes or the financial institution-defined payment attributes to the one or more routing rules to determine the payment routing.

32. The apparatus of claim 31, wherein the payment route determination sub-module is further operable to receive the one or more payor-defined payment attributes, one or more payee-defined payment attributes or one or more financial institution-defined payment attributes, wherein each attribute is further defined as being related to at least one of time of payment, cost of payment, payment risk, remittance requirements or destination of payment.

33. The apparatus of claim 31, wherein the payment route determination sub-module is further operable to access at least one of a payor profile database, a payee profile database or a financial institution database to retrieve the one or more payor-defined payment attributes, one or more payee-defined payment attributes or one or more financial institution-defined payment attributes.

34. The apparatus of claim 31, wherein the payment route determination sub-module is further operable to receive the one or more payor-defined payment attributes, one or more payee-defined payment attributes or one or more financial institution defined payment attributes, wherein the attributes are defined by the payor, payee or the financial institution at or near an inception of the financial payment request.

35. A computer program product, comprising:
a computer-readable medium comprising:
a first set of codes for causing a computer to receive a plurality of international financial payment requests from a plurality of different payment input channels, wherein the international payment requests require foreign currency exchange;
a second set of codes for causing a computer to pool the plurality of international financial payment requests based at least in part on currencies involved in the foreign currency exchange;
a third set of codes for causing a computer to determine an optimal foreign currency exchange for each of the pooled plurality of international financial payment requests so as to maximize profitability of a financial institution processing the international payment requests;
a fourth set of codes for causing a computer to exchange currency of the pooled plurality of international payment requests in accordance with the determined optimal foreign currency exchange; and
a fifth set of codes for causing a computer to provide payment for the plurality of international financial payment requests in the exchanged currency.

36. The computer program product of claim 35, wherein the first set of codes is further operable to cause the computer to receive a plurality of international payment requests wherein a plurality of the requests require present time payment processing.

37. The computer program product of claim 36, wherein the second set of codes is further operable to cause the computer to pool the plurality of international financial payments based at least in part on the requests requiring present time payment processing.

38. The computer program product of claim 35, wherein the first set of codes is further operable to cause the computer to receive a plurality of international payment requests wherein a plurality of the requests require future payment processing.

39. The computer program product of claim 38, wherein the first set of codes is further operable to cause the computer to receive a plurality of international payment requests, wherein a plurality of the requests require at least one of one-time only future payments or recurring payments.

40. The computer program product of claim 38, wherein the second set of codes is further operable to cause the computer to pool the plurality of international financial payments based at least in part on the requests requiring future payment processing.

41. The computer program product of claim 35, wherein the first set of codes is further operable to cause the computer to receive a plurality of international payment requests wherein a first plurality of the requests require immediate payment processing and a second plurality of requests require future payment processing.

42. The computer program product of claim 41, wherein the second set of codes is further operable to cause the computer to pool the plurality of international financial payments based at least in part on a predetermined time interval for processing the payment of the first plurality of the requests and a portion of the second plurality of the requests.

43. The computer program product of claim 35, wherein the third set of codes is further operable to cause the computer to determine an optimal foreign currency exchange rate for each of the pooled plurality of international financial payment requests.

44. The computer program product of claim 35, wherein the third set of codes is further operable to cause the computer to determine an optimal point in time for the exchange to occur for each of the pooled plurality of international financial payment requests.

45. The computer program product of claim 35, further comprising a sixth set of codes for causing a computer to determine payment routing for each of the plurality of international payment requests based on one or more routing rules and providing for financial payment to a payee via the determined payment route in the exchanged currency.

46. The computer program product of claim 45, wherein the sixth set of codes is further operable to cause the computer to determine the payment routing based on one or more routing rules, wherein the routing rules are associated with one or more of payment processing time, payment processing cost, payment processing risk, payment destination or remittance requirements.

47. The computer program product of claim 45, wherein the sixth set of codes is further operable to cause the computer to determine the payment routing based on one or more routing rules, wherein the one or more routing rules are operable to determine a least-cost payment type that meets time requirements and risk requirements.

48. The computer program product of claim 45, further comprising a seventh set of codes for causing a computer to receive at least one of one or more payor-defined payment attributes, one or more payee-defined payment attributes or one or more financial institution-defined payment attributes and wherein the sixth set of codes is further operable to cause the computer to apply one or more of the payor-defined payment attributes, the payee-defined payment attributes or the financial institution-defined payment attributes to the one or more routing rules to determine the payment routing.

49. The computer program product of claim 48, wherein the seventh set of codes is further operable to cause the computer to receive the one or more payor-defined payment attributes, one or more payee-defined payment attributes or one or more financial institution-defined payment attributes, wherein each attribute is further defined as being related to at least one of time of payment, cost of payment, payment risk, remittance requirements or destination of payment.

50. The computer program product of claim 48, wherein the seventh set of codes is further operable to cause the computer to access at least one of a payor profile database, a payee profile database or a financial institution database to retrieve the one or more payor-defined payment attributes, one or more payee-defined payment attributes or one or more financial institution defined payment attributes.

51. The computer program product of claim 48, wherein the seventh set of codes is further operable to cause the computer to receive the one or more payor-defined payment attributes, one or more payee-defined payment attributes or one or more financial institution defined payment attributes, wherein the attributes are defined by the payor, payee or the financial institution at or near an inception of the financial payment request.
